(19) United States
(12) Patent Application Publication
(10) Pub. No.: US 2014/0360158 A1
(43) Pub. Date: Dec. 11, 2014

(54) TWIN-DOOR THRUST REVERSER

(71) Applicant: AIRCELLE, GONFREVILLE L'ORCHER (FR)

(72) Inventors: Patrick Gonidec, Bretx (FR); Laurent Albert Blin, Sainte Adresse (FR); Xavier Bouteiller, Le Havre (FR); LoÏc Chapelain, Thiais (FR)

(21) Appl. No.: 14/328,967

(22) Filed: Jul. 11, 2014

Related U.S. Application Data
(63) Continuation of application No. PCT/FR2013/050105, filed on Jan. 17, 2013.

(30) Foreign Application Priority Data
Jan. 17, 2012 (FR) 12/50429

(51) Int. Cl. F02K 1/32

(52) U.S. Cl. CPC F02K 1/32; F05D 2260/901
USPC 60/226.2; 239/265.19

(57) ABSTRACT

A thrust reverser for aircraft turbojet engine nacelle includes at least one upstream door and a downstream door. The upstream and downstream doors move in concert between a direct jet position and a reverse jet position. In the direct jet position, two doors are closed, and in the reverse jet position the two doors are open and able to deflect a part of a cold air flow circulating inside the nacelle. The thrust reverser further includes a curved downstream edge of the upstream door to make adapted a part of cold air flow circulating between an upper camber of the upstream door and a lower camber of the downstream door.

### CROSS-REFERENCE TO RELATED APPLICATIONS

This application is a continuation of International Application No. PCT/FR2013/050105, filed on Jan. 17, 2013, which claims the benefit of FR 12/50429, filed on Jan. 17, 2012. The disclosures of the above applications are incorporated herein by reference.

### FIELD

The present disclosure relates to a twin door-type thrust reverser for an aircraft turbojet engine nacelle.

### BACKGROUND

The statements in this section merely provide background information related to the present disclosure and may not constitute prior art.

It is known from the prior art, and in particular from patent application FR2574565, a twin door-type thrust reverser, each pair of twin doors comprising an upstream door and a downstream door.

Such a thrust reverser allows a large rate of leakage of the cold air circulating inside the nacelle, and hence a braking that is all the more efficient of the aircraft upon landing.

### SUMMARY

The present disclosure provides a thrust reverser for aircraft turbojet engine nacelle, comprising at least one pair of twin doors, this pair comprising an upstream door and a downstream door which move in concert between a “direct jet” position in which these two doors are closed, and a “reverse jet” position in which these two doors are open and able to deflect at least part of the cold air flow liable to circulate inside the nacelle, this thrust reverser being characterized in that it comprises means for making adapted the part of cold air flow circulating between the upper camber of said upstream door and the lower camber of said downstream door, these adapting means comprising means for minimizing the effects of a separation of the boundary layer of said part of cold air flow located on the upper camber of said upstream door.

It is meant by “adapted” on the one hand that said cold air flow has substantially parallel streamlines on practically the whole section thereof, and on the other hand, that the flow rate of this part of the air flow is increased.

This notion of adaptation, familiar to the mechanics of fluids, allows to obtain a thrust reversal air flow of which the stability and the flowing speed are improved.

Thanks to these features, an air flow of which the counter-thrust force is maximized can be sent upstream of the nacelle, and turbulences and return of air flow can be avoided in the area located in the vicinity of the upper camber of the downstream door, liable to harm the stability and the flowing speed of the air.

According to other features of the thrust reverser according to the present disclosure, taken alone or in combination:
said means for reducing the effects of a separation of the boundary layer comprise a curved downstream edge of said upstream door;
said curved edge exhibits a profile selected from the group comprising the evolutionary profiles in particular circular or elliptic or parabolic per pieces or spline/B-Spline (function defined by pieces of polynomials) with a controlled bend radius;
the radius of said curved edge is substantially equal to half the thickness of said upstream door in the area of its downstream edge: it is noted that in practice such a radius is particularly suitable;
said means for reducing the effects of a separation of the boundary layer comprise a sufficient overlap distance of the upper camber of the upstream door by the lower camber of the downstream door, for providing the parallelism of the streamlines of the air flow circulating between these two doors;
said overlap distance is just enough to provide said parallelism and hence the aerodynamic adaptation of said flow with the ambient air located behind the upper camber of the upstream door, and thus this allows to increase the surface of the upper camber of the upstream door which is not facing the lower camber of the downstream door, and thus improve the lift effect created by the flowing of the air flow circulating along this surface, thus significantly contributing to the sought counter-thrust effect;
said overlap distance substantially ranges between half and 1.2 times the distance separating said doors: it is noted in practice that such an overlap distance is just enough for providing said parallelism;
the downstream edge of said upstream door comprises an elastic skirt, able to provide the aerodynamic continuity between the upstream and downstream doors when they are in direct jet position, and to fold along said downstream edge when said doors are in reverse jet position: this elastic skirt prevents disrupting the flowing of the air flow along the downstream edge of the upstream door, and thus to not alter the benefit provided by the particular geometry of this downstream edge.

The present disclosure also relates to a nacelle for aircraft turbojet engine, characterized in that it comprises a thrust reverser in accordance with what precedes.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1 and 2 represent, in longitudinal half-section, a portion of a nacelle for aircraft double-flow engine, equipped with a twin-door type thrust reverser according to the present disclosure, respectively in “direct jet” and “indirect jet” positions;

FIGS. 3 and 4 are detailed views of area III of FIG. 1, in positions respectively corresponding to those of FIGS. 1 and 2; and

FIG. 5 is a similar view to that of FIGS. 3 and 4 of a clamshell-type thrust reverser with twin doors according to the present disclosure, equipping a mixed flow turbojet engine, in “reverse jet” position.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

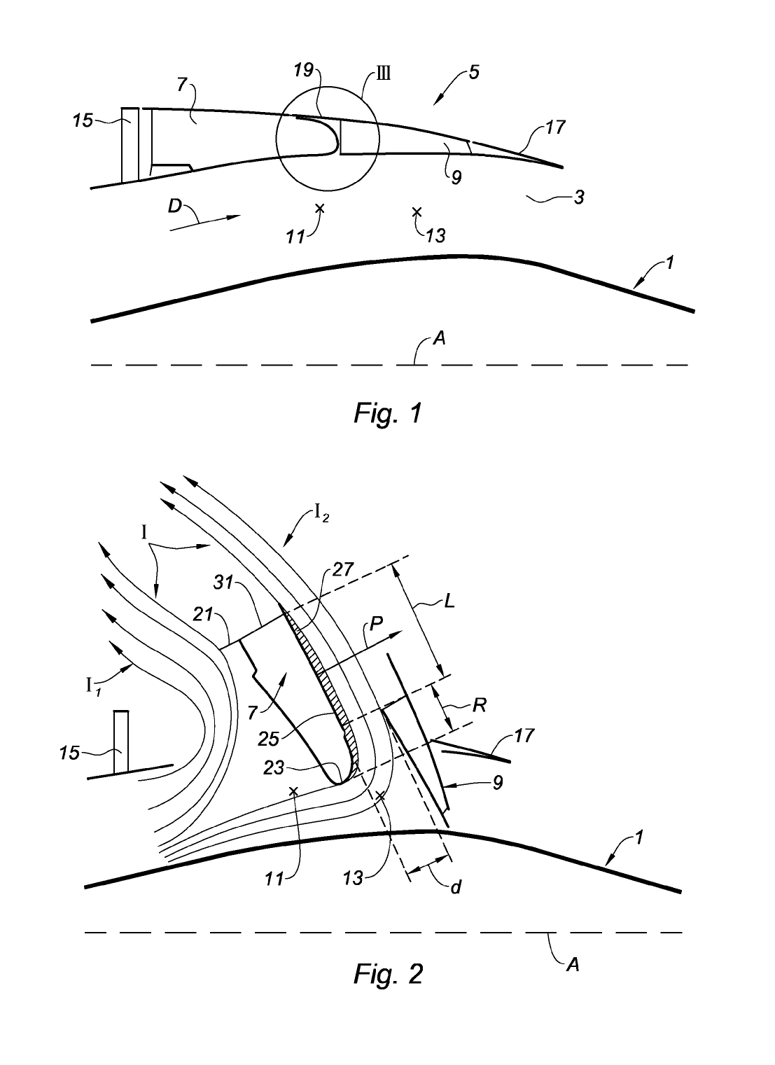

With reference to FIG. 1, on which can be seen a stationary inner structure of a nacelle, intended to act as a fairing around a dual-flow aircraft turbojet engine (not represented).

The axis A of this turbojet engine is indicated in dots on FIGS. 1 and 2, the upstream portion of this turbojet engine being on the left of the figures, and the downstream portion on the right of these figures.

The stationary inner structure 1 may technically be formed from a composite material, and may exhibit acoustic absorption features intended to minimize the noise caused by the circulation of the cold air flow in the cold air path 3.

This substantially annular cold air path 3, is defined on the one hand by the stationary inner structure 1, and on the other hand by the peripheral portion of the nacelle, classically comprising a thrust reversal device 5.

Such a thrust reversal device is movable between the configuration visible on FIG. 1, called “direct jet”, in which the cold air flow D circulates inside the path 3 from upstream to downstream of the nacelle, and the configuration visible on FIG. 2, called “reverse jet” in which the cold air flow I is rejected toward the upstream of the nacelle, in such a manner as to exert a counter-thrust force.

The “direct jet” configuration corresponds to the take-off and sustained flight situations of the aircraft, and the “reverse jet” situation corresponds to the landing situation of the aircraft, in which the braking distance is sought to be minimized.

More particularly, within the scope of the present disclosure, the thrust reversal device 5 is of the twin door type.

This means that the deflection of the cold air flow toward the upstream of the nacelle is obtained by means of two doors, respectively upstream 7 and downstream 9, articulated around respective rotation axes 11 and 13.

It should be understood that several pairs of such twin doors may be provided at the periphery of the nacelle, however, only one such pair being represented on the accompanying figures for the sake of simplicity.

The upstream door 7 extends between the front frame 15, which is a stationary portion of the nacelle, and the downstream door 9.

This downstream door 9 extends between the upstream door 7 and the rear edge 17 of the nacelle.

In the configuration of FIG. 1, the two doors 7 and 9 are closed, thus forcing the cold air flow D entrained by the turbojet engine fan (not represented) to circulate inside the cold air path 3, thus providing the thrust required for the propulsion of the aircraft (“direct jet” configuration).

It is worth noting that the downstream door 9 comprises, on the external upstream edge thereof, a skin 19 which advances to the external downstream edge of the upstream door 7, thus providing the aerodynamic continuity of the outside of the nacelle.

When it is sought to reverse the thrust of the nacelle, and hence switch to a “reverse jet” configuration, the two doors 7 and 9 are opened by making them swivel around their respective axes 11 and 13, in such a manner as to bring them to their position visible on FIG. 2.

In this configuration, a part I1 of the cold air flow circulating inside the path 3 is deflected upstream of the nacelle by the upstream door 7.

It is worth noting that a deflector forming portion 21 (often called spoiler), secured to the upstream internal edge of the upstream door 7, contributes to this air flow I1 deflecting movement.

This spoiler may be either stationary or foldable in direct jet according to its size and integration to the aerodynamic lines of the reverser.

Another part I2 of the cold air flow moves between the downstream edge 23 of the upstream door 7 and the stationary inner structure 1 of the nacelle 1, then is deflected by the downstream door 9 which itself completely blocks the cold air path 3.

As in any flowing of fluid, the circulation of the air flow I2 on the upper camber 25 of the upstream door 7 causes a boundary layer 27, appearing in a hatched manner on FIG. 2 (principal view).

Such a boundary layer is an area in which the speed profiles changes from 0 on the wall of the upper camber 25 to the free flowing speed I2 at a certain distance from this upper camber.

This distance depends on many parameters, among which the viscosity of the considered fluid (air in the present case).

An observed issue in this type of twin door type thrust reverser, is the separation of the boundary layer 27 with respect to the upper camber 25: such a separation may bring about a turbulence area between the boundary layer and the upper camber 25, even leading to sonic throat choking of the flow 12. In this case the rate of the flow I2 is severely limited and very important head losses intervene as well as a recompression by shock of the flowing I2 above the upper camber 25.

It is understood that such an uncontrolled separation I2 of the boundary layer is highly penalizing in the present application, where it consists in obtaining the most directive and powerful air flow I2 possible.

In order to overcome this risk of separation of the boundary layer, within the scope of the present disclosure, it is provided that the downstream edge 23 of the upstream door 7 be curved as is visible on all the accompanying figures.

This curve may be for example circular or elliptical.

In the case where this curve is circular, its radius may be substantially equal to half the thickness of the upstream door 7 in the area of its downstream edge 23.

This curved shape of the downstream edge 23 allows to provide that the air flow I2 follows as close as possible the upper camber 25 of the upstream door 7, thus limiting the effects of a separation of the boundary layer 27.

In order to prevent such a separation, it is also provided that the overlap distance R of the upstream door 7 by the downstream door 9, substantially measured along the direction of the air flow I2, is sufficient to straighten out the streamlines of this flow in such a manner that they be substantially parallel with each other and also with the upper camber 25 of the upstream door 7.

In one form, it is selected the distance R in such a manner that said overlapping be just enough for providing the aforementioned parallelism.

This allows to increase the distance L taken along the direction of the streamlines of the flow I2 and separate the upstream edge 29 of the downstream door 9 from the upstream edge 31 of the upstream door 7.

In doing so, the surface of the upper camber 25 which is not facing the downstream door 9 is freed as much as possible.

The arrangement increases the lift force P caused by the air 12 circulating on the upper camber 25.

This lift P, which comprises a powerful component opposing the thrust caused by the turbojet engine, significantly contributes to the braking effect caused by the thrust reversal device.

It has been noted that for example an overlap distance R comprises between half and 1.2 times the distance d separating the two doors 7 and 9, was just enough for providing the parallelism of the two streamlines I2, thus allowing to improve the lift force P, and that an overlapping R equal to the distance also gave good results.

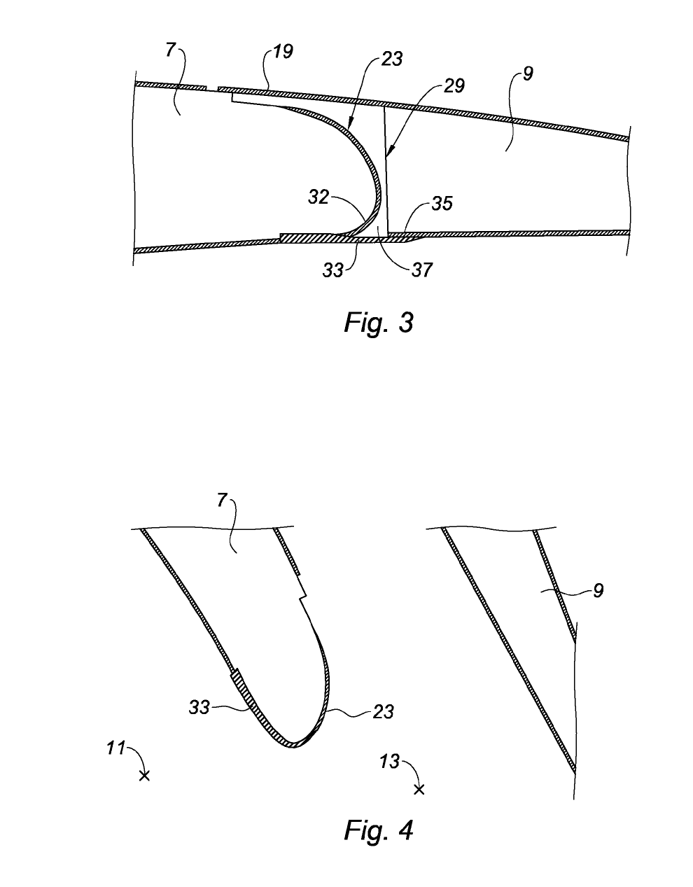

In another form, as is visible on FIGS. 3 and 4, the internal portion 32 of the downstream edge 23 of the upstream door 7, comprises an elastic skirt 33 able to extend to the internal portion 35 of the upstream edge 29 of the downstream door 9.

By means of this elastic skirt, when the two doors 7 and 9 are in a “direct jet” configuration, the aerodynamic continuity is provided inside the cold air path 3, despite the curved shape of the downstream edge 23 of the upstream door 7 which necessarily defines a cavity 37.

In “reverse jet” configuration (see FIGS. 2 and 4), the elastic skirt 33 is pressed by the flow I2 along the downstream edge 23 of the upstream door 7 (see FIG. 4), thus allowing the perfect flowing of the air flow I2 along this downstream edge 23.

As can be understood in light of the preceding description, the present disclosure allows on the one hand to provide more stable and faster flow I2, due to the suppression of the separation risk of the boundary layer 27: this way the counter-thrust force exerted by this flow I2 is increased.

Furthermore, by reducing the overlapping of the upper camber 25 of the upstream door 7 by the lower camber of the downstream door 9, the lift P caused by the flow I2 circulation on the upper camber of the upstream door is increased, thus significantly adding to the counter-thrust force caused by the air flow I2.

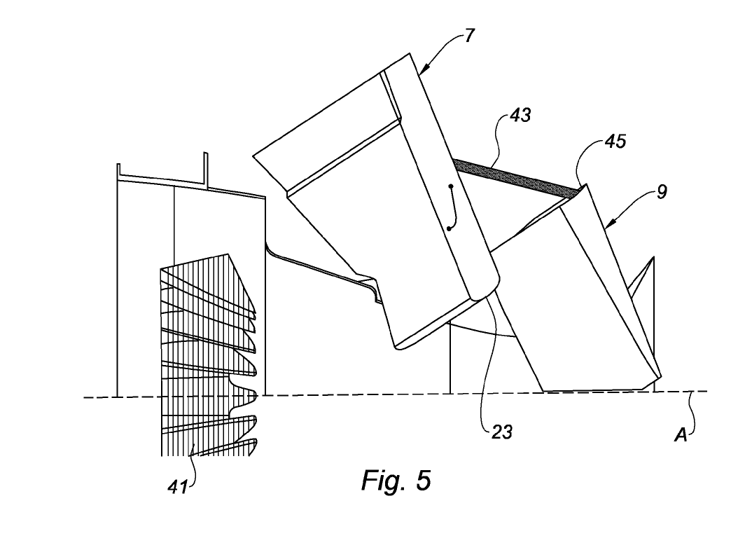

It is thus for example that the precepts of the present disclosure may be applied to a twin-door “clamshell” type thrust reverser for mixed-flow turbojet engine, visible on the accompanying FIG. 5 in “reverse jet” position.

In such a thrust reverser, suitable for small nacelles, there are two pairs of twin doors 7, 9 (one of these two pairs being represented on FIG. 5) placed diametrically opposite, and the hot and cold air flows are mixed upstream of these two pairs of doors, in a mixing member 41 found downstream of the turbojet engine (the latter not being represented).

The twin doors 7, 9 of each pair are connected together by at least one connecting rod 43.

In “direct jet” position (not represented), the downstream edges 23 of the upstream door 7 and upstream of the downstream door 9 are joined, and thus block the outlet of the mixed hot and cold flows, which are rejected in their entirety toward the front of the nacelle.

In “reverse jet” position, represented on FIG. 5, the mixed hot and cold flows are separated into flow I1 and I2 as in the previous form, these two flows changing respectively upstream of the upstream door 7, and between this upstream door 7 and the downstream door 9.

What is claimed is:

1. A thrust reverser for an aircraft turbojet engine nacelle, comprising:
at least one pair of doors, the at least one pair of doors comprising an upstream door and a downstream door which move in concert between a direct jet position and a reverse jet position, wherein in the direct jet position, the upstream and downstream doors are closed, and in the reverse jet position, the upstream and downstream doors are open and able to deflect at least part of a cold air flow circulating an inside the nacelle; and
adapting means configured to adapt a part of the cold air flow circulating between an upper camber of the upstream door and a lower camber of the downstream door, the adapting means comprising means for reducing effects of a separation of a boundary layer of the part of the cold air flow circulating between the upper camber and the lower camber, the boundary layer being located on the upper camber of the upstream door.

2. The thrust reverser according to claim 1, wherein the means for reducing the effects of the separation of the boundary layer comprise a curved downstream edge of the upstream door.

3. The thrust reverser according to claim 2, wherein the curved edge exhibits an evolutionary profile.

4. The thrust reverser according to claim 3, wherein the evolutionary profile is selected from a group consisting of circular, elliptic, parabolic per pieces, and spline/B-Spline with a controlled bend radius.

5. The thrust reverser according to claim 2, wherein a radius of the curved downstream edge is substantially equal to half of a thickness of the upstream door in an area of the curved downstream edge thereof.

6. The thrust reverser according to claim 1, wherein the means for reducing the effects of the separation of the boundary layer comprises an overlap distance (R) of the upper camber of the upstream door by the lower camber of the downstream door, the overlap distance providing a parallelism of streamlines of the cold air flow circulating between the upstream and downstream doors.

7. The thrust reverser according to claim 6, wherein the overlap distance (R) provides an aerodynamic adaptation of the cold air flow with an ambient air located behind the upper camber of the upstream door.

8. The thrust reverser according to claim 7, wherein the overlap distance (R) ranges between 0.5 and 1.2 times a distance (d) between the upstream and downstream doors.

9. The thrust reverser according to claim 2, wherein the curved downstream edge of the upstream door comprises an elastic skirt to provide an aerodynamic continuity between the upstream and downstream doors when they are in the direct jet position, the elastic skirt being folded along the curved downstream edge when the upstream and downstream doors are in the reverse jet position.

10. The thrust reverser according to claim 9, wherein the elastic skirt extends to an internal portion of an upstream edge of the downstream door.

11. A nacelle for aircraft turbojet engine comprising the thrust reverser according to claim 1.
